(19) United States
(12) Patent Application Publication
(10) Pub. No.: US 2010/0041581 A1
(43) Pub. Date: Feb. 18, 2010

(54) Aqueous cleaning composition

(75) Inventors: Sylvia C. VanGrasstek, Stillwater, MN (US); Frank P. Lochel, Delano, MN (US)

Correspondence Address: DUFAULT LAW FIRM, P.C., 700 LUMBER EXCHANGE BUILDING, TEN SOUTH FIFTH STREET, MINNEAPOLIS, MN, 55402, US

(73) Assignee: Lubrication Technologies, Inc., Golden Valley, MN (US)

(21) Appl. No.: 12/370,975

(22) Filed: Feb. 13, 2009

Related U.S. Application Data
(60) Provisional application No. 61/028,433, filed on Feb. 13, 2008.

(51) Int. Cl. C11D 1/825

(52) U.S. Cl. 510/405

(57) ABSTRACT

A water soluble, non-emulsified cleaning composition for removing contaminants, especially paint and overspray, from a surface comprises from about 1 to about 90 weight percent of an aliphatic glycol diether and from about 1 to about 90 weight percent of an aliphatic glycol monoether. Water can be added to form a working solution from about 0.001 to about 90 weight percent of the entire composition. The resulting aqueous cleaning composition exhibits a pH between about 6.0 and 8.0 and a vapor pressure of less than about 0.8 millimeters of mercury at 20° C.

### CROSS-REFERENCE TO RELATED APPLICATION(S)

This application claims the benefit of U.S. Provisional Patent Application No. 61/028,433 entitled AQUEOUS CLEANING COMPOSITION, filed on 13 Feb. 2008, which is hereby incorporated herein by reference.

### BACKGROUND OF INVENTION

The present invention generally relates to commercial cleaning compositions. More particularly, the present invention relates to non-emulsified, aqueous cleaning compositions which aid in the removal of contaminants such as grease, oil, paint, paint sludge, tar, asphalt, underbody rust protection coatings and adhesives from surfaces, including for example paint overspray deposited on walls, floors, windows, equipment, hoses and the like during the process of painting or coating an object.

During the process of spray painting an object, at least some of the paint being sprayed does not contact the intended object and eventually drifts onto an unintended object, such as the floor, walls, equipment or windows surrounding the area in which the spray painting occurs. This is referred to as overspray. The surfaces upon which overspray can deposit may include any range of surfaces including hard or flexible surfaces, and smooth or porous surfaces, with said surfaces being made of metal, wood, glass, rubber or plastic materials. In certain circumstance the painting may occur in a controlled environment in which the surfaces affected by overspray can be selected to be more durable and achieve easier removal of the overspray. However, over time the accumulation of overspray needs to be removed to ensure safe working conditions and ensure the integrity of the overall manufacturing process.

For example, in the automobile industry, many parts are conveyed through special chambers in assembly line fashion to be spray painted or coated. According to some estimates, as much as 40% of the paint being sprayed misses the intended object and eventually ends up on unintended surfaces. Such surfaces include the floor, walls and windows of the chamber. Further, it is quite common to have robotic arms with spray nozzles contained within the chamber to apply the spray paint. These too can become covered in paint. In addition, the paint or coating material tends to migrate outside the chamber through air drafts, foot traffic, equipment traffic and the like. Eventually, the accumulation of the overspray on unintended surfaces must be removed. For example, the accumulation of clear coat onto viewing windows must eventually be removed, otherwise the window will not be able to be seen through.

The overspray and paint sludge can be removed from the unintended surfaces by either mechanical or chemical means. Mechanical means may include the use of abrasives, wire brushes, meshes and sharpened instruments, such as razor blades, to physically remove the overspray from the unintended surface. These means of removing overspray and paint sludge, however, have their disadvantages in that they are time and labor intensive, and can be dangerous to workers. Moreover, such mechanical means are either an inefficient or ineffective way of removing overspray from porous materials, or surfaces which are not hard and smooth. In fact, it may be impossible to fully remove all of the overspray by mechanical means alone. Further, mechanical means of removing overspray may damage the unintended surface, either abruptly or gradually, resulting in having to replace or refurbish the surface, which may include a piece of equipment or viewing glass.

A variety of chemical means for removing overspray have been employed in the prior art to remove overspray, amongst other contaminants as well. In order to be effective, though, it is desirable that the chemical processes should be quick and provide complete removal of the overspray without damaging the unintended surface. Such chemical means have traditionally included chemical compositions containing undesirable quantities of volatile organic compounds such as aliphatic and aromatic solvents, non-ethoxylated alcohols, amines, ketones and chlorinated solvents. For example, compositions containing xylene, or ethyl benzene, are widely employed in the automobile industry to remove paint and paint sludge. Examples of such products include Cyclosol #52/GP-100 as made commercially available by Gage Products Company of Ferndale, Mich., and Shellsol A100 as made commercially available by Shell Chemicals Company. However, due to recent government regulations based upon increased consumer safety and environmental concerns, it is desirable to reduce the use of volatile organic compounds. Unfortunately, with a vapor pressure of approximately 7 mm of Hg at 20° C., xylene is a highly volatile organic compound. Moreover, these solvents are typically sprayed at a rate of approximately one gallon per minute onto a surface or object to remove overspray and paint sludge. To clean one side of a one square meter window with these products typically takes about five minutes of spraying to remove about 80% of the overspray, leaving the window surface hazy or tacky. Additionally, to clean an entire painting chamber as used in the automobile manufacturing industry, nearly 500 gallons of solvent and four and one-half hours of labor are needed. When the above solvents are used, they are one time use products because the paint solids dissolve into the solvent, thereby rendering the used solutions not reusable.

Other chemical compositions, such as acetone, are exempt as being classified as volatile organic compounds by the United States Environmental Protection Agency even though they exhibit extremely high vapor pressures. Acetone, though, while being able to satisfactorily remove some paints and residues, is difficult to contain because of its high evaporation rate and relatively low flash point (i.e., <−9° C.). This makes such compositions unsatisfactory for many commercial purposes.

For both environmental and economic reasons, it is also desirable to provide a non-corrosive cleaner. Water based cleaning formulations having a neutral pH are therefore preferred. It is, however, difficult to provide an effective aqueous cleaning composition that reduces volatile organic compound levels while providing acceptable evaporation rates, has a non-corrosive pH, and cleans as effectively as aliphatic solvents, aromatic solvents, alcohols, amines, ketones, chlorinated solvents, other solvents, caustics, and acids.

There exist several examples in the prior of cleaning compositions employing water based emulsions and micro-emulsions for removing paint and contaminants. Such compositions, however, have inherent deleterious traits in that separation of the miscible components may occur during transport, or during storage thereof. Further, emulsions and micro-emulsions tend to be corrosive (acidic or caustic), have unsatisfactory evaporation rates, and also tend to leave oily residues on the surfaces in which they are applied. Such emulsions and micro-emulsions may also contain components deemed not to be environmentally friendly.

Accordingly, there is a need for an environmentally friendly, non-corrosive, aqueous-based, low volatile organic compound chemical composition, substantially free if not entirely free of aromatic solvents, chlorinated solvents, ketones, amines and strong acids, which is applicable to a variety of surfaces to thoroughly and easily remove overspray, paint sludge, grease, tar, asphalt, underbody protective coatings and adhesives from said surfaces.

### BRIEF SUMMARY OF INVENTION

The present invention includes an aqueous cleaning composition that effectively reduces volatile organic compound levels, performs in a non-corrosive pH range, and effectively dissolves and removes paint, overspray, paint sludge, grease, oil, tar, asphalt, underbody coatings and adhesives from floors, walls, mats, equipment and windows. The aqueous cleaning composition of the present invention generally comprises a first solute and a second solute mixed with water, wherein the water is in sufficient amount to act as a solvent. The first solute includes a water soluble aliphatic glycol ether (excluding glycol diethers) component. The second solute includes a water soluble glycol diether component. The resulting aqueous cleaning composition exhibits a vapor pressure equal to or less than 0.8 mm Hg at 20° C., a pH range of between about 6.0 and 8.0 and a flash-point of 149° F. (Setaflash closed cup). The aqueous cleaning composition may optionally include a surface active agent or a corrosion inhibitor. The composition constituents of the present invention do not include, and effectively replace, aromatic solvents, oil soluble aliphatic solvents, non-ethoxylated alcohols, amines, ketones, chlorinated solvents, caustics and acids. The aqueous cleaning composition of the present invention can also be reused until it eventually loses its efficacy.

### DETAILED DESCRIPTION

The present invention provides a cleaning composition completely soluble in water for removing contaminants such as paint, overspray and paint sludge from floors, walls, grates and windows within an area or enclosure in which a spray painting process is used, and also for removing the same from any equipment or tools contained therein as well. For purposes of this specification, the term overspray will generally refer to the application of any form of paint, resins, sprayable coatings, varnish, stain or other airborne particulate material deposited onto an unintended surface. Also for purposes of this specification, the term paint sludge will generally refer to an accumulation of overspray, or any other accumulation of paint, resins, sprayable coatings, varnish or stain. The cleaning composition of the present invention can be referred to as an aqueous cleaning composition with the addition of water in instances where a concentrated form of the cleaning composition is utilized. The cleaning composition can also be employed in environments other than where paint is being applied. In accordance therewith, the present invention further provides a cleaning composition for removing glue, wood coatings, grease, grime, oil, tar, asphalt, underbody protective coatings, tire marks, decals and adhesives from a variety of substrate surfaces, including but not limited to metal surfaces including stainless steel surfaces, painted surfaces, glass surfaces, cement surfaces, wood surfaces, porcelain surfaces, vitreous tile surfaces, ceramic tile surfaces, plastic surfaces and the like.

The present invention further includes a process for cleaning a substrate by providing the aqueous cleaning solution in accordance with the present invention and effectively contacting the substrate to be cleaned to substantially remove the aforementioned contaminants therefrom. The aqueous cleaning composition of the present invention can be directly applied to the surface to be cleaned, or can be applied thereto by means of a mop, moistened cloth, sponge or the like.

The present invention was developed in response to eliminating the use of xylene, ethyl benzene and other volatile organic compounds, including those exempt by the EPA from being classified as such, for dissolving and removing overspray, paint and paint sludge from floors, walls, equipment and windows. Considerations involved in the development process of the present invention were to match the cleaning performance of xylene based cleaning compositions while reducing volatile organic compound levels, obtaining acceptable evaporation rates and achieving a non-corrosive pH level. For purposes of this specification, acceptable cleaning performance includes the substantial removal of overspray and residues from a surface in a one-step process, without a post-rinse step, while leaving the surface streak free. For purposes of this specification, acceptable evaporations rates include drying times of 30 seconds or less, wherein the time is measured from the point after removing the cleaning composition with a mop, rag or squeegee from the substrate surface until the surface is substantially free of a liquid presence and not slippery. Further, for purposes of this specification, non-corrosive pH ranges preferably include a pH range of between about 2.0 and 12.5, and more preferably between about 6.0 and 8.0.

The aqueous cleaning composition of the present invention generally includes a first solute component mixed with a second solute component. The cleaning composition further includes water acting as a solvent. A surface active agent (“surfactant”) or a corrosion inhibitor may be optionally added dependent upon the specific application. The cleaning composition of the present invention does not include, and effectively replaces, oil soluble aliphatic solvents, aromatic solvents, non-ethoxylated alcohols, amines, ketones, chlorinated solvents, caustics and acids. It should be noted that it is well within the scope of the present invention to provide the cleaning composition in concentrated form, either having less water or substantially free of water, to reduce volume and mass of the product for purposes of lowering transportation costs or reduce the amount of space needed to store the composition. Water can later be added to the concentrate by the end user to make a working solution in accordance with the present invention. The working solution of the present invention is prepared by mixing together the aforementioned components in any order at room temperature.

The first solute component includes an aliphatic glycol ether component, excluding glycol diethers. The aliphatic glycol ether component used as a solute in the present invention can include either an ethylene oxide based material, a propylene oxide based material and any combination thereof. Examples of suitable ethylene oxide based materials, excluding glycol diethers, for use in the present invention include, but are not limited to, ethylene glycol monomethyl ether, ethylene glycol monoethyl ether, ethylene glycol monopropyl ether, ethylene glycol monobutyl ether, ethylene glycol monohexyl ether, ethylene glycol phenyl ether, diethylene glycol methyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, and any mixture thereof. Examples of suitable propylene oxide based materials, excluding glycol diethers, include, but are not limited to propylene glycol monomethyl ether, propylene glycol monopropyl ether, propylene glycol monobutyl ether, propylene glycol t-butyl ether, propylene glycol phenyl ether, dipropylene glycol monomethyl ether, dipropylene glycol monopropyl ether, dipropylene glycol monobutyl ether, tripropylene glycol methyl ether, tripropylene glycol n-butyl ether, and any mixture thereof. Ethylene glycol monobutyl ether (2-butoxyethanol) is the preferred aliphatic glycol ether for use in the present invention.

The second solute component of the present invention includes a glycol diether, or glyme. The glycol diethers suitable for use in the present invention include monoethylene glycol dimethyl ether (monoglyme), diethylene glycol dimethyl ether (diglyme), triethylene glycol dimethyl ether (triglyme), tetraethylene glycol dimethyl ether (tetraglyme), dipropylene glycol dimethyl ether (proglyme) or diethylene glycol dibutyl ether (butyl glyme), and any mixture thereof. The preferred glycol diether for use in the present invention includes dipropylene glycol dimethyl ether, which is commercially available from Clariant Corporation of Charlotte, North Carolina, or under the trade name PROGLYDE® DMM by the Dow Chemical Company of Midland, Mich.

The aqueous cleaning composition of the present invention provides numerous advantages and benefits. For example, it has been suprisingly discovered that by employing the glycol diether component with the alkyl glycol monoether component in an aqueous solvent, there is a synergistic effect on cleaning performance not seen in other aqueous based detergent compositions or compositions containing volatile organic compounds having an equal or lesser vapor pressure than that as exhibited by the aqueous cleaning composition of the present invention. Furthermore, it has been discovered that the aqueous cleaning composition of the present invention breaks the paint sludge bonds by separating the solvent from paint solids, allowing the paint solids to fall to the bottom of the cleaning solution. This allows cleaning composition of the present invention to work better on more surfaces than originally intended and allows the solution to retain its efficacy through multiple reuses.

The surfactant, which is optional and not necessarily essential to practice the present invention, may be included up to about 20 weight percent of the cleaning composition. The surfactant is meant to reduce surface tension and can include any number of nonionics, anionics, cationics, or amphoterics including, but not limited to, nonylphenoxypolyethoxyethanols, octylphenoxypolyethoxyethanols, block copolymers based on ethylene oxide and propylene oxide, amphoterics, betaines and amine oxides. The surfactant for use in the present invention preferably includes a detergent range alcohol ethoxylate, including ethoxylated alcohols having between nine and eleven carbon atoms. Such preferred ethoxylated alcohols include, for example, TOMADOL® 91-6 and NEODOL® 91-6. TOMADOL® 91-6 is made commercially available through Air Products and Chemicals, Inc. of Allentown, Pennsylvania. NEODOL® 91-6 is made commercially available in the United States through Shell Chemical LP of Houston, Tex.

The corrosion inhibitor, which is optional and not necessarily essential to practice the present invention, can be added up to 50 weight percent of the cleaning composition of the present invention. The corrosion inhibitor (or inhibitors) is added to prevent metal corrosion on metal surfaces that have been cleaned with the aqueous cleaning composition of the present invention. Exemplary corrosion inhibitor additives and combinations for use in the aqueous cleaning composition of the present invention include, but are not limited to: amines including triethanolamine, monoethanolamine, and diethanolamines; borates including sodium borate, and calcium borate; borate esters such as amine borate esters; silicates including potassium silicate, sodium silicate, and metasilicates; alkanolamides; carboxylates such as amine salts of dibasic acids; nitrates; nitrites; azelaic and sebacic acid salts and esters; phosphate esters; and castor oil.

In a first embodiment of the cleaning composition of the present invention, the aliphatic glycol ether component comprises up to about 90 weight percent of the total cleaning composition, the glycol diether component comprises up to about 90 weight percent of the total cleaning composition, and the surfactant component comprises up to about 20 weight percent of the cleaning composition, with the remainder including water at about 0-90 weight percent. Preferably, the first embodiment of the present invention includes the alkyl glycol monoether component comprising about 10-40 weight percent of the total cleaning composition, the glycol diether component comprising about 5-25 weight percent of the total cleaning composition, and the surfactant component comprising about 0-5 weight percent of the total cleaning composition, with the remainder being water at about 50-85 weight percent. More preferably, the first embodiment of the present invention includes the alkyl glycol monoether component comprising approximately 25.000 weight percent of the total cleaning composition, the glycol diether component comprising approximately 15.000 weight percent of the total cleaning composition, and the surfactant component comprising approximately 0.036 weight percent of the cleaning composition, with the remainder including water at approximately 59.964 weight percent. The following Table 1 lists the most preferred composition of the aqueous cleaning composition, as a working solution, in accordance with the first embodiment of the present invention.

TABLE 1
Most Preferred Composition of First
Embodiment (percent total weight)

| | |
|---|---|
| Water | 59.964% |
| 2-Butoxyethanol | 25.000% |
| Dipropylene Glycol Dimethyl Ether | 15.000% |
| Alcohols, C9-11, ethoxylated | 0.036% |

The following Table 2 summarizes the physical data associated with the working solution of the most preferred embodiment of the aqueous cleaning composition as contained in Table 1.

TABLE 2
Physical Data of Aqueous Cleaning Composition of Table 1

| | |
|---|---|
| Form: | Liquid |
| Color: | Clear |
| Odor: | Slight solvent |
| Specific Gravity (Water = 1): | 0.975-0.980 @ 24° C |
| Boiling Point: | 100° C. |
| Evaporation Rate (Water = 1) | <1.0 |
| pH of working solution: | 6.5-7.5 |
| pH (1% volume): | 7.0-8.0 |
| Solubility in Water: | Complete |
| Vapor Density (Air = 1): | >4 |
| % Volatile Organic Compounds: | <40% (3.25 lbs per gallon) |
| Vapor Pressure: | <0.8 mm Hg @ 20° C. |
| Flash Point: | 149° F. (Setaflash closed cup) |

Alternatively, if a concentrated form is desired, it will be understood by those skilled in the art that the proportion of water in the working solution can be lessened, even to the point of containing no water, to form the concentrate. The preferred concentrated cleaning composition, being substantially free of water, includes the alkyl glycol monoether component comprising about 62.44 weight percent of the total concentrated cleaning composition, the glycol diether component comprising about 37.47 weight percent of the concentrated cleaning composition, and the surfactant component comprising about 0.09 weight percent of the concentrated cleaning composition. Similar to the working solution, the concentrate can be prepared by mixing together the aforementioned components in any order at room temperature. The working solution can be derived from the concentrate simply by adding the appropriate amount of water to the concentrate.

In a second embodiment of the cleaning composition of the present invention, the alkyl glycol monoether component comprises up to about 90 weight percent of the total cleaning composition, the glycol diether component comprises up to about 90 weight percent of the total cleaning composition, the surfactant component comprises up to about 20 weight percent of the cleaning composition, and the corrosion inhibitor comprises up to about 50 weight percent of the cleaning composition, with the remainder including water at about 0-90 weight percent. Preferably, the second embodiment of the present invention includes the alkyl glycol monoether component comprising about 10-40 weight percent of the total cleaning composition, the glycol diether component comprising about 5-25 weight percent of the total cleaning composition, the surfactant component comprising about 0-5 weight percent of the total cleaning composition, and the corrosion inhibitor component comprising about 0-10 with the remainder being water at about 50-85 weight percent. Most preferably, the second embodiment of the present invention includes the alkyl glycol monoether component comprising approximately 25.000 weight percent of the total cleaning composition, the glycol diether component comprising approximately 15.000 weight percent of the total cleaning composition, and the surfactant component comprising approximately 0.036 weight percent of the cleaning composition, the corrosion inhibitor component comprising approximately 0.600 weight percent of the cleaning composition, with the remainder including water at approximately 59.364 weight percent. The following Table 3 lists the most preferred composition of the aqueous cleaning composition, as a working solution, in accordance with the second embodiment of the present invention.

TABLE 3
Most Preferred Composition of Second
Embodiment (percent total weight)

| | |
|---|---|
| Water | 59.364% |
| 2-Butoxyethanol | 25.000% |
| Dipropylene Glycol Dimethyl Ether | 15.000% |
| Alcohols, C9-11, ethoxylated | 0.036% |
| CORFREE ® M1 | 0.200% |
| Triethanolamine | 0.200% |
| Monoethanolamine | 0.200% |

CORFREE® M1 is a nitrite-free dibasic acid mixture made commercially available through INVISTA S.ar.l. of Wilmington, Del.

### COMPARATIVE EXAMPLES

The cleaning composition of the present invention provides an environmentally preferred aqueous solution, low in volatile organic compounds, and effective at removing paint, resins, varnish, stain, glue, wood coatings, grease, grime, oil, tar, asphalt, tire marks, decals and adhesives from a variety of substrate surfaces including, but not limited to, metal surfaces including stainless steel surfaces, glass surfaces, cement surfaces, wood surfaces, porcelain surfaces, vitreous tile surfaces, ceramic tile surfaces, plastic surfaces and the like.

### Comparative Example 1

In support thereof, a working solution of the aqueous cleaning composition of the present invention was prepared in accordance with the components as contained in Table 1. Approximately 0.1 gallons of the working solution was applied, by means of a mop, to a glass surface of approximately one square meter containing paint overspray. A squeegee was applied to the glass surface to remove excess solution and the dissolved overspray, whereby 99-100% of the overspray was removed from the glass surface in approximately one minute. No rinse was required and the glass was streak-free and substantially dry in approximately 30 seconds.

### Comparative Example 2

Similar to Comparative Example 1, a like amount of the working solution of the present invention in accordance with Table 1 was applied by means of a mop to a similar area of concrete containing tacky overspray. The overspray contained on the floor was entirely removed after one and one-half minutes with assistance with a floor squeegee. No rinse was required and the floor was streak-free and substantially dry in approximately 30 seconds.

### Comparative Example 3

A coco coir mat containing paint solids and paint sludge was allowed to soak in an appropriate amount of the working solution of the present invention in accordance with Table 1 for ten minutes. The mat was then rinsed off with water. The cleaning composition of the present invention in accordance with Table 1 broke down and dissolved the paint solids and paint sludge, leaving the mat substantially free of any paint residue. Additionally, to test the coco coir mat for compatibility, the mat was soaked in the same cleaning composition for two months after which no deleterious effects to the mat were observed.

### Comparative Example 4

A working solution of the aqueous cleaning composition of the present invention was prepared in accordance with the components as contained in Table 3. This sample was made with an amine salt of dibasic acids to prevent flash corrosion of cast iron chips. The cast iron chips were submerged in solution for 1 minute, then removed and left to air dry. The chips remained corrosion free for more than 48 hours.

Although the present invention has been described with reference to preferred embodiments, workers skilled in the art will recognize that changes may be made in form and detail without departing from the spirit and scope of the invention.

1. A water soluble, non-emulsified cleaning composition for removing contaminants from a surface comprising:
from about 1 to about 90 weight percent of a first aliphatic glycol ether; and
from about 1 to about 90 weight percent of a second aliphatic glycol ether, the second aliphatic glycol ether different than the first aliphatic glycol ether, wherein the resulting cleaning composition exhibits a pH between about 2.0 and 12.5 and a vapor pressure of less than about 0.8 millimeters of mercury at 20° C.

2. The cleaning composition of claim 1 wherein the first aliphatic glycol ether includes a glycol diether and the second aliphatic glycol ether includes a glycol monoether.

3. The cleaning composition of claim 2 wherein the glycol diether includes dipropylene glycol dimethyl ether.

4. The cleaning composition of claim 1 and further comprising from about 0.001 to about 90 weight percent of water.

5. The cleaning composition of claim 4 wherein the first aliphatic glycol ether is selected from the group consisting of monoethylene glycol dimethyl ether, diethylene glycol dimethyl ether, triethylene glycol dimethyl ether, tetraethylene glycol dimethyl ether, dipropylene glycol dimethyl ether, diethylene glycol dibutyl ether, and mixtures thereof.

6. The cleaning composition of claim 4 wherein the second aliphatic glycol ether is selected from the group consisting of ethylene glycol monomethyl ether, ethylene glycol monoethyl ether, ethylene glycol monopropyl ether, ethylene glycol monobutyl ether, ethylene glycol monohexyl ether, ethylene glycol phenyl ether, diethylene glycol methyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, propylene glycol monomethyl ether, propylene glycol monopropyl ether, propylene glycol monobutyl ether, propylene glycol t-butyl ether, propylene glycol phenyl ether, dipropylene glycol monomethyl ether, dipropylene glycol monopropyl ether, dipropylene glycol monobutyl ether, tripropylene glycol methyl ether, tripropylene glycol n-butyl ether, and mixtures thereof.

7. The cleaning composition of claim 4 wherein the composition exhibits a pH between about 6.0 and 8.0

8. The cleaning composition of claim 7 wherein the composition exhibits a pH between 6.5 and 7.5.

9. The composition of claim 4 and further comprising:
from about 5 to 25 weight percent of the first aliphatic glycol ether;
from about 10 to 40 weight percent of the second aliphatic glycol ether;
from about 50 to 85 weight percent water.

10. The composition of claim 9 and further comprising:
about 15 weight percent of the first aliphatic glycol ether;
about 25 weight percent of the second aliphatic glycol ether;
about 60 weight percent water.

11. A non-emulsified aqueous cleaning composition for substantially removing at least one contaminant from a surface, the cleaning composition consisting essentially of:
from about 10 to 40 weight percent of an aliphatic glycol monoether;
from about 5 to 25 weight percent of a glycol diether; and
from about 50 to 85 weight percent water.

12. The cleaning composition of claim 11 wherein the glycol diether includes dipropylene glycol dimethyl ether.

13. The composition of claim 11 exhibiting a vapor pressure of less than about 0.8 millimeters of mercury at 20° C.

14. The composition of claim 13 exhibiting a pH between about 6.0 and 8.0.

15. The composition of claim 14 exhibiting a pH between about 6.5 and 7.5.

16. An aqueous, non-emulsified cleaning composition for substantially removing paint from a substrate surface, the composition comprising:
from about 0.001 to about 90 weight percent of an aliphatic glycol ether;
from about 0.001 to about 90 weight percent of a glycol diether; and
from about 0.001 to about 90 weight percent of water, wherein the resulting aqueous cleaning composition exhibits a vapor pressure of less than about 0.8 millimeters of mercury at 20° C.

17. The cleaning composition of claim 16 wherein the glycol diether includes dipropylene glycol dimethyl ether.

18. The cleaning composition of claim 16 wherein the aliphatic glycol ether is selected from the group consisting of ethylene glycol monomethyl ether, ethylene glycol monoethyl ether, ethylene glycol monopropyl ether, ethylene glycol monobutyl ether, ethylene glycol monohexyl ether, ethylene glycol phenyl ether, diethylene glycol methyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether, propylene glycol monomethyl ether, propylene glycol monopropyl ether, propylene glycol monobutyl ether, propylene glycol t-butyl ether, propylene glycol phenyl ether, dipropylene glycol monomethyl ether, dipropylene glycol monopropyl ether, dipropylene glycol monobutyl ether, tripropylene glycol methyl ether, tripropylene glycol n-butyl ether, and mixtures thereof.

19. The composition of claim 16 and further comprising:
from about 10 to 40 weight percent of the alkene glycol ether;
from about 5 to 25 weight percent of the glycol diether; and
from about 50 to 85 weight percent water.

20. The composition of claim 19 and further comprising from about 0.001 to 5 weight percent of a surfactant.

21. The cleaning composition of claim 20 and further comprising from about 0.001 to about 5 weight percent of a corrosion inhibitor.
